(19) United States
(12) Patent Application Publication
(10) Pub. No.: US 2025/0327728 A1
(43) Pub. Date: Oct. 23, 2025

(54) EVALUATION SYSTEM, EVALUATION METHOD, AND PROGRAM

(71) Applicant: TEIKYO UNIVERSITY, Tokyo (JP)

(72) Inventors: Toshimitsu YOKOBORI, Tokyo (JP); Go OZEKI, Tokyo (JP)

(73) Assignee: TEIKYO UNIVERSITY, Tokyo (JP)

(21) Appl. No.: 18/870,975

(22) PCT Filed: May 25, 2023
(86) PCT No.: PCT/JP2023/019571

§ 371 Date: Dec. 2, 2024

(30) Foreign Application Priority Data
Jun. 2, 2022 (JP) 2022-090493

(51) Int. Cl. G01N 3/18; G01N 3/60

(52) U.S. Cl. CPC G01N 3/18; G01N 3/60; G01N 2203/0003; G01N 2203/0017; G01N 2203/0019; G01N 2203/0071; G01N 2203/0226; G01N 2203/0682

(57) ABSTRACT

An evaluation system for evaluating target members is provided. The evaluation system comprises an information processing device having a processor. The processor is configured to: in a first acquiring step, acquire reference information related to a relationship between a first physical amount and a second physical amount for a reference material, wherein a target material of the target member and the reference material belong to a group of materials, and wherein the first physical amount and the second physical amount for the reference material are different physical amounts related to a creep test of a reference member composed of the reference material; in a second acquiring step, acquire a first physical amount related to a creep test performed on the target member; and in an evaluating step, evaluate a second physical amount of the target member based on the reference information and the first physical amount of the target member.

### CROSS-REFERENCE TO RELATED APPLICATIONS

This application is a National Stage filing under 35 U.S.C. 371 of International Application No. PCT/JP2023/019571, filed May 25, 2023, which claims priority to JP Application No. 2022-090493, filed Jun. 2, 2022, which are incorporated by reference in their entireties.

### TECHNICAL FIELD

Embodiments of the present invention relate to an evaluation system, an evaluation method, and a program.

### BACKGROUND ART

Creep is a phenomenon in which a material deforms and eventually fractures in response to a load in a high-temperature environment. Generally, a creep test using a creep tester is performed to investigate the creep properties of materials (see Patent Document 1).

### CITATION LIST

### Patent Document

### Patent Document 1

Japanese Unexamined Patent Application, First Publication No. H10-170415.

### SUMMARY OF INVENTION

### Technical Problem

However, in many cases, a creep test generally takes longer than 1000 hours.

The problem to be solved by the invention is to provide an evaluation system, an evaluation method, and a program that can efficiently evaluate creep properties.

### Solution to Problem

The invention may include the following aspects.

[1] An evaluation system for evaluating a target member, comprising an information processing device having a processor,
wherein the processor is configured to:
in a first acquiring step, acquire reference information related to a relationship between a first physical amount and a second physical amount for a reference material, wherein a target material of the target member and the reference material both belong to a certain group of materials, and wherein the first physical amount and the second physical amount for the reference material are different physical amounts related to a creep test of a reference member composed of the reference material;
in a second acquiring step, acquire a first physical amount related to a creep test performed on the target member; and
in an evaluating step, evaluate a second physical amount of the target member based on the reference information and the first physical amount of the target member.

[2] The evaluation system according to [1], wherein the reference information includes one or more first parameters for specifying a relationship between the first physical amount and the second physical amount for the reference material, and
wherein the processor is configured to evaluate the second physical amount of the target member from the first physical amount of the target member using one or more of the one or more first parameters.

[3] The evaluation system according to [2], wherein the certain group of materials is a group consisting of one or more materials for which one or more of the one or more first parameters can be used in common when the second physical amount is evaluated from the first physical amount.

[4] The evaluation system according to any one of [1] to [3], wherein the first physical amount is a steady-state creep rate, and
wherein the second physical amount is a creep fracture life.

[5] The evaluation system according to [4], wherein the reference information includes information of a parameter M=(dε/dt)_{S}^{α}·t_{f} for the reference material, where (dε/dt)_{S} is the steady-state creep rate of the reference member, α is a constant, and t_{f} is the creep fracture life of the reference member.

[6] The evaluation system according to [5], wherein the reference information includes information of the parameter a for the reference material.

[7] The evaluation system according to any one of claims [1] to [6], wherein the reference information includes information related to a correspondence relationship between the first or second physical amount for the reference material and a third physical amount for the reference material, and
wherein the processor is configured to, in a conversion step, acquire an amount corresponding to the third physical amount, as a converted third physical amount, from the first or second physical amount of the target member, assuming that the correspondence relationship for the reference material is also valid for the target member.

[8] The evaluation system according to [7], wherein the reference information includes one or more second parameters for specifying the correspondence relationship, and
wherein the processor is configured to, in the conversion step, calculate an amount corresponding to the third physical amount, as a converted third physical amount, from the first or second physical amount of the target member, using one or more of the one or more second parameters.

[9] The evaluation system according to [7] or [8], wherein the processor is configured to:
acquire a third physical amount in the creep test performed on the target member; and
evaluate a material property of the target material based on the acquired third physical amount and the converted third physical amount.

[10] The evaluation system according to [9], wherein the material property to be evaluated is resistance to creep deformation.

[11] The evaluation system according to any one of [7] to [10], wherein the third physical amount is an applied stress at the start of a test in a creep test.

[12] The evaluation system according to any one of [1] to [11], wherein the processor is configured to:
in a third acquiring step, acquire second reference information related to a relationship between a first physical amount and a second physical amount for the target material; and
in the evaluating step, evaluate the second physical amount of the target member based on the reference information, the second reference information, and the first physical amount of the target member.

[13] The evaluation system according to any one of [1] to [12], wherein the reference information includes a data set indicating a relationship between a first physical amount and a second physical amount for a plurality of reference materials, and
wherein the processor is configured to:
identify a reference material which corresponds to the target material among the plurality of reference materials; and
in the first acquiring step, acquire information related to a relationship between a first physical amount and a second physical amount for the identified reference material.

[14] The evaluation system according to any one of [1] to [13], wherein the target material and the reference material have the same principal constituent element that is the constituent element having the largest mass %.

[15] The evaluation system according to any one of [1] to [14], wherein the target material and the reference material have the same chemical constituents as each other.

[16] The evaluation system according to any one of [1] to [15], wherein the target material and the reference material are one or more selected from the group consisting of heat resistant steel and stainless steel.

[17] The evaluation system according to any one of [1] to [16], further comprising a test device configured to perform a creep test,
wherein the test device is configured to perform a creep test on the target member, and
wherein the processor is configured to acquire a result of the creep test from the test device.

[18] An evaluation method for evaluating a target member, comprising a first acquiring step, a second acquiring step, and an evaluating step,
wherein the first acquiring step includes acquiring reference information related to a relationship between a first physical amount and a second physical amount for a reference material, wherein a target material of the target member and the reference material both belong to a certain group of materials, the first physical amount and the second physical amount for the reference material are different physical amounts related to a creep test of a reference member composed of the reference material,
wherein the second acquiring step includes acquiring a first physical amount related to a creep test performed on the target member, and
wherein the evaluating step includes evaluating a second physical amount of the target member based on the reference information and the first physical amount of the target member.

[19] The evaluation method according to [18], further comprising the step of performing a creep test on the target member and terminating the creep test before fracture of the target member.

[20]A program for causing a processor of an information processing device to evaluate a target member,
wherein the program causes the processor to:
acquire reference information related to a relationship between a first physical amount and a second physical amount for a reference material, wherein a target material of the target member and the reference material both belong to a certain group of materials, and wherein the first physical amount and the second physical amount for the reference material are different physical amounts related to a creep test of a reference member composed of the reference material;
acquire a first physical amount related to a creep test performed on the target member; and
evaluate a second physical amount of the target member based on the reference information and the first physical amount of the target member.

[21] An information processing system, comprising an information processing device having a processor,
wherein the processor is configured to:
acquire reference information related to a correspondence relationship between a basis physical amount and a particular physical amount for a reference material, wherein a target material of the target member and the reference material both belong to a certain group of materials, and wherein the basis physical amount and the particular physical amount for the reference material are different physical amounts related to a creep test of a reference member composed of the reference material;
acquire a basis physical amount related to a creep test performed on the target member; and
acquire an amount corresponding to a particular physical amount, as a converted particular physical amount, based on the basis physical amount of the target member, assuming that the correspondence relationship for the reference material is also valid in the target member.

[22] The information processing system according to [21], wherein the basis physical amount is a steady-state creep rate or a creep fracture life.

[23] The information processing system according to [21] or [22], wherein the particular physical amount is an applied stress at the start of a test in a creep test.

[24] The information processing system according to any one of [21] to [23], wherein the reference information includes one or more second parameters for specifying the correspondence relationship, and wherein the processor is configured to, in a conversion step, calculate an amount corresponding to a target physical amount, as a converted particular physical amount, from the basis physical amount of the target member, using one or more of the one or more second parameters.

[25] The information processing system according to any one of [21] to [24], wherein the processor is configured to:
acquire a particular physical amount in the creep test performed on the target member; and
evaluate a material property of the target material based on the acquired particular physical amount and the converted particular physical amount.

[26] The information processing system according to [25], wherein the material property to be evaluated is resistance to creep deformation.

[27] An information processing method, comprising a first acquiring step, a second acquiring step, and a converting step,
wherein the first acquiring step includes acquiring reference information related to a correspondence relationship between a basis physical amount and a particular physical amount for a reference material, wherein a target material of the target member and the reference material both belong to a certain group of materials, and wherein the basis physical amount and the particular physical amount for the reference material are different physical amounts related to a creep test of a reference member composed of the reference material;
wherein the second acquiring step includes acquiring a basis physical amount related to a creep test performed on the target member; and
wherein the converting step includes acquiring an amount corresponding to a particular physical amount, as a converted particular physical amount, based on the basis physical amount of the target member, assuming that the correspondence relationship for the reference material is also valid in the target member.

[28]A program causing a processor of an information processing device to:
acquire reference information related to a correspondence relationship between a basis physical amount and a particular physical amount for a reference material, wherein a target material of the target member and the reference material both belong to a certain group of materials, and wherein the basis physical amount and the particular physical amount for the reference material are different physical amounts related to a creep test of a reference member composed of the reference material;
acquire a basis physical amount related to a creep test performed on the target member; and
acquire an amount corresponding to a particular physical amount, as a converted particular physical amount, based on the basis physical amount of the target member, assuming that the correspondence relationship for the reference material is also valid in the target member.

### Advantageous Effects of Invention

Embodiments of the present invention can provide an evaluation system, an evaluation method, and a program that can efficiently evaluate creep properties.

### BRIEF DESCRIPTION OF DRAWINGS

FIG. 1 a schematic diagram of the entire configuration of the evaluation system 1 according to the first embodiment.

FIG. 2 a graph showing an example of a creep curve C obtained by a creep test.

FIG. 3 a block diagram showing the functional configuration of the evaluation device 20 in the first embodiment.

FIG. 4 an example of a double logarithmic graph in which creep fracture life is plotted with respect to steady-state creep rate.

FIG. 5 a conceptual diagram showing an example of the relationship between the reference material RM and the target material TM.

FIG. 6 a double logarithmic plots of steady-state creep rate and creep fracture life obtained from fracture creep tests of P91 and P92 steels.

FIG. 7 a double logarithmic plots of steady-state creep rate and creep fracture life obtained from fracture creep tests of ½-inch and 1-inch CT specimens of P92 steel.

FIG. 8 a double logarithmic plots of steady-state creep rate and creep fracture life obtained from fracture creep tests of weld joint member WJ1 and weld joint member WJ2.

FIG. 9 a double logarithmic plots of steady-state creep rate and creep fracture life obtained from fracture creep tests of a notched member and a smooth member.

FIG. 10 a double logarithmic plots of steady-state creep rate and creep fracture life obtained from fracture creep tests of a notched member and a smooth member.

FIG. 11 a flowchart showing an example of the processing flow for evaluating the creep fracture life t_{f} of the target member T in the first embodiment.

FIG. 12 a flowchart showing an example of the processing flow for evaluating the material properties of a target member T in the first embodiment.

FIG. 13 a flowchart showing an example of the processing flow for evaluating the creep fracture life t_{f} of the target member T in the first embodiment.

FIG. 14 a block diagram showing the functional configuration of the evaluation device 20 in the second embodiment.

FIG. 15 an example of the data structure of the reference material DB 244.

FIG. 16 a flowchart showing an example of the processing flow for evaluating the creep fracture life t_{f} of the target member T in the second embodiment.

FIG. 17 a flowchart showing an example of the processing flow for evaluating the material properties of the target material TM in the second embodiment.

### DESCRIPTION OF EMBODIMENTS

The following is a description of an evaluation system, an evaluation method, and a program according to embodiments with reference to the drawings. The drawings are schematic or conceptual; the relationship between the thickness and width of each part and the size ratio between parts may not necessarily be the same as in reality. Even if the same part is represented, the dimensions and proportions may differ from each other depending on the drawing.

As used herein, “based on XX” means “based on at least XX”, including cases where it is based on another factor as well as based on XX. In addition, “based on XX” is not limited to cases where XX is used directly, but also includes cases where it is based on information obtained by calculations or processing on XX. “XX” is an arbitrary element (e.g., information).

### Overview

In evaluating a member in relation to a creep test, the inventors have found that a certain parameter related to a creep test can be used in common among several materials belonging to a certain group of materials. Based on this discovery, the inventors have developed a method for efficiently evaluating the creep properties of a target member T by applying parameters of a known reference material RM to the evaluation of the target member T, in a case where the target material TM of the target member T to be evaluated and the known reference material RM belong to the certain group of materials. The inventors have also developed a method to easily evaluate the material properties of the target material TM of the target member T by performing a conversion calculation based on the known reference material RM.

### First Embodiment

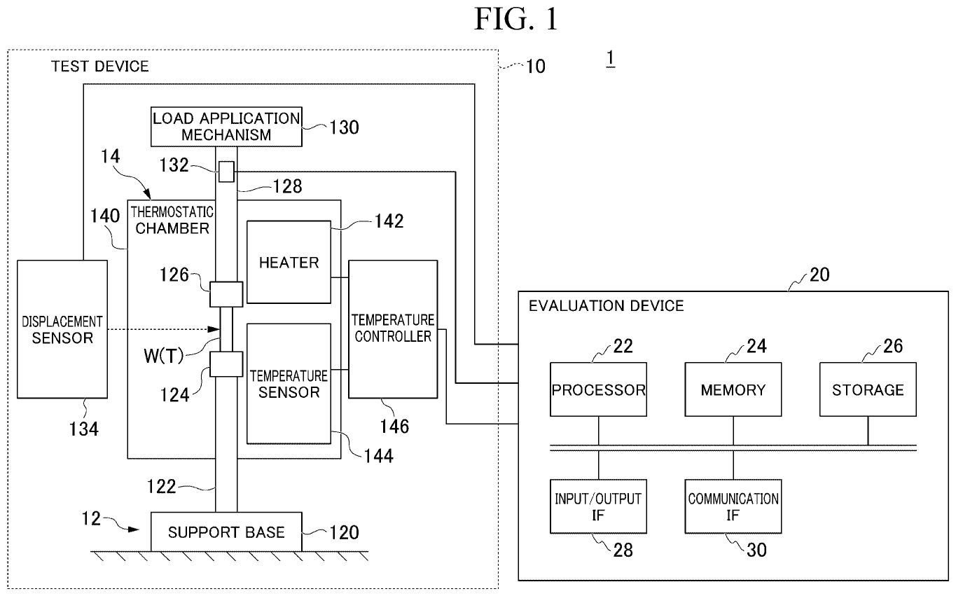

Referring to FIGS. 1 to 13, the evaluation system 1 according to the first embodiment is described.

### [1. Configuration of Evaluation System 1]

First, the entire configuration of the evaluation system 1 is described with reference to FIG. 1. FIG. 1 is a schematic diagram of the entire configuration of the evaluation system 1 according to the first embodiment. The evaluation system 1 evaluates a target member T. Specifically, as shown in FIG. 1, the evaluation system 1 has a test device 10 and an evaluation device 20 (an example of an “information processing device”).

The test device 10 and the evaluation device 20 are connected by wire or wirelessly, directly or via any network. The test device 10 and the evaluation device 20 may be located in close proximity (e.g., in the same room) or at a remote location. The test device 10 and evaluation device 20 may be integrated into a single unit. The “evaluation system” may consist of only a single device (e.g., evaluation device 20). In that case, the test may be performed by a test device external to the system, and the evaluation system 1 (i.e., the evaluation device 20) receives the test results from the outside and evaluates the target member T.

### A. Test Device 10)

Referring to FIG. 1, the configuration of the test device 10 is described. The test device 10 performs a creep test on a specimen W. Specifically, the test device 10 can acquire the steady-state creep rate (dε/dt)_{S} (an example of “first physical amount”) and creep fracture life t_{f} (an example of “second physical amount”) of a test subject member provided as a test specimen W, such as target member T and reference member R described below, by performing a creep test on the test subject member. Here, the steady-state creep rate (dε/dt)_{S} and creep fracture life t_{f} are different physical amounts related to the creep test of the test subject member, as described below. The following describes the tensile creep test specified in JIS Z 2271 (2010), but the test device 10 can also be used for other tests to examine creep properties, such as the compression creep test.

As shown in FIG. 1, the test device 10 has a main body 12 and a heating mechanism 14. The main body 12 supports the specimen W to be tested and applies a load to the specimen W to measure the strain of the specimen W. The heating mechanism 14 heats the specimen W to maintain a certain temperature.

(Main body 12)

The main body 12 has a support base 120, a lower rod 122, a lower fixing portion 124, an upper fixing portion 126, an upper rod 128, a load application mechanism 130, a load sensor 132, and a displacement sensor 134. The specimen W is sandwiched between the lower fixing portion 124 and the upper fixing portion 126 and stretched in the vertical direction.

The support base 120 supports the test device 10. The lower rod 122 is a rod-like member extending upward from the support base 120. The lower fixing portion 124 is provided at the upper end of the lower rod 122 to fix the lower end of the specimen W. The load application mechanism 130 generates a load to be applied to the specimen W. The upper rod 128 is a rod-like member extending downward from load application mechanism 130. The upper fixing portion 126 is provided at the lower end of the upper rod 128 to fix the upper end of the specimen W.

The upper rod 128 and the upper fixing portion 126 are displaced in the vertical direction in accordance with the load generated by the load application mechanism 130. For example, when the load application mechanism 130 applies an upward force to the upper rod 128, an upward force is applied to the upper end of the specimen W via the upper rod 128 and the upper fixing portion 126. Meanwhile, the lower fixing portion 124 continues to fix the lower end of the specimen W. This causes the specimen W to stretch in the vertical direction in response to the load from the load application mechanism 130. The specific constitution of the load application mechanism 130 is not limited, and any known constitution can be used, such as a mechanism using a weight or an electric motor. The magnitude of the load generated by the load application mechanism 130 may be set manually or controlled by the evaluation device 20 or a load control device not shown.

The load sensor 132 measures the load (e.g., upward tensile force) applied to the specimen W from the load application mechanism 130. As the specific constitution of the load sensor 132, any known constitution can be used such as a strain gauge. The location of the load sensor 132 is not limited. The load sensor 132 transmits the measured values to the evaluation device 20.

The displacement sensor 134 measures the displacement of the specimen W (e.g., strain ε corresponding to the amount of elongation of the specimen W). As the specific constitution of the displacement sensor 134, any known constitution can be used such as a strain gauge, an image sensor, an infrared sensor, etc. The location of the displacement sensor 134 is not limited. The displacement sensor 134 transmits the measured values to the evaluation device 20.

### (Heating Mechanism 14)

The heating mechanism 14 has a thermostatic chamber 140, a heater 142, a temperature sensor 144, and a temperature controller 146.

The thermostatic chamber 140 houses the specimen W inside and maintains a constant internal temperature during the creep test. The heater 142 provides heating in the thermostatic chamber 140. The temperature sensor 144 measures the temperature inside the thermostatic chamber 140. The temperature controller 146 is connected to the heater 142 and the temperature sensor 144 and control the heating operation of the heater 142. For example, the temperature controller 146 controls the operation of the heater 142 such that the thermostatic chamber 140 is maintained at a certain temperature based on the measurement results of the temperature sensor 144. The temperature controller 146 transmits the measurements of the temperature sensor 144 and the contents of the temperature control to the evaluation device 20.

i. Creep Test)

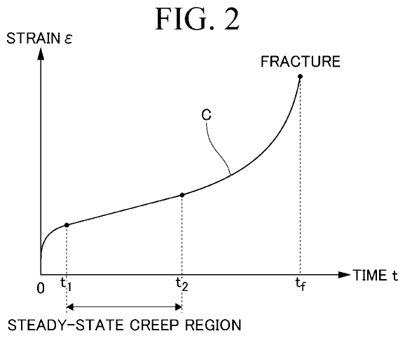

Then, a creep test is described with reference to FIG. 2. FIG. 2 shows an example of a creep curve C obtained by a creep test.

The test device 10 acquires the measurement results from the load sensor 132 and the displacement sensor 134 at regular time intervals. By plotting the strain ε measured by the displacement sensor 134 with respect to the time t, a creep curve C is obtained, as shown in FIG. 2. In general, the strain ε measured in a creep test increases rapidly immediately after the start of measurement, the rate of increase gradually slows down, and then the rate of increase of strain ε becomes almost constant (the region of t=t₁ to t=t₂ in FIG. 2; this region is referred to as a “steady-state creep region”). Then, the strain 8 increases again, and finally the specimen W fractures (t=t_{f} in FIG. 2; the time t_{f} required from the start of the creep test to the fracture is referred to as a “creep fracture life”). The strain rate dε/dt in the steady-state creep region is referred to as the steady-state creep rate (dε/dt)_{S}.

For example, a steady-state creep region can be detected as a region where the variation in strain rate dε/dt is maintained within a certain range (e.g., within 5%, 10%, or 15%) over a certain time. The steady-state creep rate (dε/dt)_{S} can be calculated as the average value of the strain rate dε/dt in the steady-state creep region.

a. Evaluation device 20)

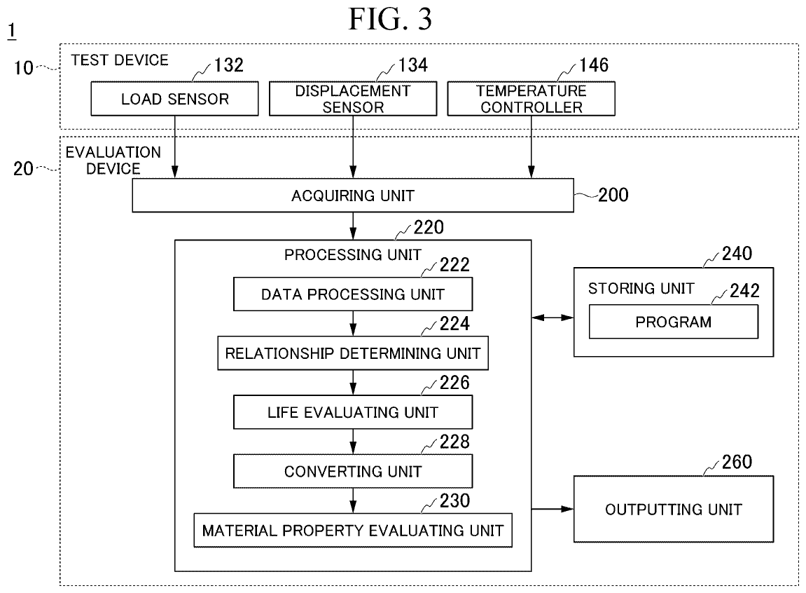

Then, the constitution of the evaluation device 20 is described with reference to FIGS. 1 and 3. The evaluation device 20 evaluates the target member T based on the results of the creep test by the test device 10. For example, the evaluation device 20 is an information processing device such as a common computer, tablet, or smartphone. The evaluation device 20 may be a user terminal or a server. The evaluation device 20 may comprise a plurality of information processing devices. Each of the plurality of information processing devices may be located in close proximity or in a remote location.

(1-2-1. Hardware configuration of the evaluation device 20)

FIG. 1 shows the hardware configuration of the evaluation device 20. As shown in FIG. 1, the evaluation device 20 has a processor 22, a memory 24, a storage 26, an input/output interface (IF) 28, and a communication interface (IF) 30.

The processor 22 is the hardware which processes the data and instructions described in the program. The processor 22 comprises, for example, a controller, arithmetic unit, and registers.

The memory 24 is hardware which temporarily stores programs and data. For example, the memory 24 is a volatile memory such as SRAM (Static Random Access Memory) or DRAM (Dynamic Random Access Memory).

The storage 26 is hardware which stores programs and data. For example, the storage 26 is non-volatile memory such as flash memory, hard disk drive (HDD), ferroelectric memory, etc.

The input/output IF 28 functions as an interface to input devices which accept input operations from a user and other inputters and to output devices which present information to a user. The input devices include pointing devices such as a mouse and a touch panel, a keyboard, etc. The output devices include a display, a speaker, etc.

The communication IF 30 is an interface which inputs and outputs signals to communicate with external devices.

### (1-2-2. Functional Configuration of Evaluation Device 20)

Then, the functional configuration of the evaluation device 20 is described with reference to FIG. 3. FIG. 3 is a block diagram showing the functional configuration of the evaluation device 20 according to the first embodiment. As shown in FIG. 3, the evaluation device 20 has an acquiring unit 200, a processing unit 220, a storing unit 240, and an outputting unit 260.

### (Acquiring Unit 200)

The acquiring unit 200 acquires various information such as user's input operations and data. The acquiring unit 200 acquires measurements of the tensile force applied to the specimen W and the displacement of the specimen W from the load sensor 132 and the displacement sensor 134, together with the time at which the measurements were performed. The acquiring unit 200 acquires the measured values of the temperature sensor 144 and the temperature control contents of the thermostatic chamber 140 from the temperature controller 146.

### (Processing Unit 220)

The processing unit 220 performs arithmetic processing on the information acquired by the acquiring unit 200. Specifically, the processing unit 220 has a data processing unit 222, a relationship determining unit 224, a life evaluating unit 226, a converting unit 228, and a material property evaluating unit 230. Hereafter, only a brief description of each component of the processing unit 220 is given, and the specific operations are described later.

The data processing unit 222 processes the data acquired by the acquiring unit 200. Specifically, the data processing unit 222 can generate a graph of the creep curve C, as shown in FIG. 2, from the data set of strain ε and time t measured by the displacement sensor 134. The data processing unit 222 can calculate the strain rate dε/dt by differentiating the strain ε with respect to time t. The data processing unit 222 can identify a steady-state creep region in the creep curve C by searching for a region where the variation of the strain rate dε/dt is within a certain range for a certain time or longer. The data processing unit 222 can calculate the average value of the strain rate dε/dt in the steady-state creep region, as a steady-state creep rate (dε/dt)_{S}. The data processing unit 222 can acquire a creep fracture life t_{f} based on the measurement results of the displacement sensor 134.

The data processing unit 222 can calculate the stress σ applied to the specimen W by dividing the load measured by the load sensor 132 by the cross-sectional area of the specimen W, which is measured separately. The cross-sectional area of specimen W may be measured as appropriate prior to the start of the test. The cross-sectional area of the specimen W may be measured before and/or during the test, as appropriate, utilizing a shape sensor which measures the external shape of the specimen W. Since the cross-sectional area of specimen W changes during the test, it is preferable to measure the change in the cross-sectional area of the specimen W over time with such a shape sensor in order to acquire an accurate stress a.

The relationship determining unit 224 identifies the relationship between the physical amounts acquired directly or indirectly by the creep test. For example, the relationship determining unit 224 can identify the relationship between the steady-state creep rate (dε/dt)_{S} and the creep fracture life t_{f}. The relationship determining unit 224 can identify the relationship between a stress σ (e.g., an initial applied stress σ₀ at the start of the test; hereafter, the initial applied stress σ₀ is simply referred to as the applied stress σ₀) and the steady-state creep rate (dε/dt)_{S}. The relationship determining unit 224 can identify the relationship between stress σ (e.g., applied stress σ₀ at the start of the test) and the creep fracture life t_{f}. Herein, information which directly or indirectly associates two or more physical amounts with each other in this manner (e.g., relational expressions, data tables, algorithms, etc.), and any information for identifying such associating information (e.g., parameters or other parameters obtained by arbitrary operations on the parameters, operators, functions etc.), are collectively referred to as information related to the relationship between the two or more physical amounts. As used herein, “the relationship between two amounts A and B” may be any of relationship between A and B, between A and B′, between A′ and B, and between A′ and B′, provided A′ and B′ are amounts obtained by performing specific operations on A and B, respectively.

The life evaluating unit 226 evaluates the creep fracture life t_{f} of the target member T for which a certain parameter is measured, based on the relationship between the certain parameter (e.g., the steady-state creep rate (dε/dt)_{S}) and the creep fracture life t_{f}, which is determined by the relationship determining unit 224. In this way, the evaluation device 20 can evaluate the creep fracture life t_{f} of the target member T.

The converting unit 228 calculates a “converted amount” which is an amount obtained by converting a certain physical amount (e.g., stress a) for the target member T with respect to the reference material RM, based on the property parameters of the reference material RM and the certain parameter of the target member T (e.g., creep fracture life t_{f} evaluated by the life evaluating unit 226). The specifics of this conversion process will be described later.

The material property evaluating unit 230 evaluates the material property of the target material TM of the target member T based on the conversion amount calculated by the converting unit 228. The material property evaluating unit 230 allows the evaluation of the creep properties of the target member T as well as the inherent material properties of the target material TM of the target member T. Examples of material properties include creep properties such as resistance to creep deformation of the target material TM (e.g., creep strength) and material properties that contribute to creep properties (e.g., matrix strength, microstructural stability). The term “creep strength” refers to the stress that causes a certain amount of strain or fracture after a certain time at a certain temperature. In this way, the evaluation device 20 can evaluate the material properties of the target material TM of the target member T.

### (Storing Unit 240)

The storing unit 240 stores the program 242, including the instructions for the arithmetic operations executed by the processing unit 220, various data acquired by the acquiring unit 200, and other data.

### (Outputting Unit 260)

The outputting unit 260 outputs the results of the arithmetic processing by the processing unit 220 to external parties. For example, the outputting unit 260 outputs the creep curve C generated by the data processing unit 222, the result of evaluating the creep fracture life t_{f} of the target member T by the life evaluating unit 226, the result of evaluating the material properties of the target material TM by the material property evaluating unit 230, etc. The output information is presented to the user by an input/output IF 28 such as a display or speaker.

The above constitutions such as the acquiring unit 200, the processing unit 220, the storing unit 240, and the outputting unit 260 are functional units realized by the cooperation of hardware configurations including the processor 22, the memory 24, the storage 26, the input/output IF 28, the communication IF 30, and buses interconnecting them.

### a. (Evaluation Subject)

The evaluation subject for which the creep properties are evaluated by the evaluation system 1 is not limited. Examples of the target material TM and the reference material RM include single-component metal materials, alloy materials, ceramic materials, and polymer materials. For example, the target material TM and the reference material RM may be steel materials (e.g., ordinary steel, special steel, heat-resistant steel, stainless steel, superalloy). Examples of heat-resistant steels include ferritic heat-resistant steels (e.g., Mo steel, Cr steel, Cr—Mo steel, Cr—Mo—V steel, 9Cr steel, 12Cr steel), austenitic heat-resistant steels (e.g., austenitic stainless steels and Fe-based superalloys), and martensitic heat-resistant steels (e.g. martensitic stainless steels). For example, the target material TM and the reference material RM are one or more selected from the group consisting of heat-resistant steel and stainless steel. For example, the target material TM and the reference material RM are materials which exhibit high-temperature ductility and follow a creep deformation similarity law. The target material TM may be a homogeneous material consisting of a single material, a homogeneous composite material including a plurality of materials uniformly mixed together, or a heterogeneous composite material including a plurality of materials heterogeneously combined. The target member T is any form of member composed of the target material TM; the shape and size of the target member T are not limited. For example, the target member T is a weld joint member WJ which has a structure of a plurality of base metals welded together with weld metal, and the reference member R is a member made of the same material as the base metal of the weld joint member WJ.

### 2. Evaluation Method

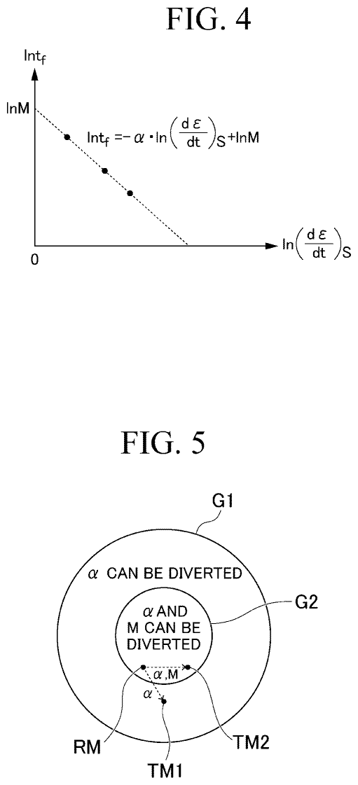

Then, with reference to FIGS. 4 to 7, the evaluation method by which the evaluation system 1 evaluates the target member T is described.

### 2-1. Principle

### (2-1-1. Evaluation of Creep Fracture Life t_{f})

First, the principle of how the evaluation system 1 evaluates the creep fracture life t_{f} of the target member T is described. The evaluation of the creep fracture life t_{f} of the target member T is based on the following equation (1). In equation (1), the QL* parameter is defined by the product of the steady-state creep rate (dε/dt)_{S} to the a-th power and the creep fracture life t_{f}. M is a material constant which represents the creep ductility of the material. Both a and M are examples of the “first parameters”. Equation (1) and the parameters α and M in equation (1) are examples of the information related to the relationship between the steady-state creep rate (an example of the “first physical amount”) and the creep fracture life (an example of the “second physical amount”).

$$[ Equation 1 ]$$

$$Q {L}^{*} ≡ {( \frac{d ε}{dt} )}_{S}^{α} \cdot {t}_{f} = M \qquad ( 1 )$$

According to equation (1), the product QL* of the steady-state creep rate (dε/dt)_{S} to the a-th power and the creep fracture life t_{f}, which are obtained by the creep test, is a constant value M regardless of the measurement conditions such as the applied stress σ₀ of the creep test and the measurement temperature.

Taking the logarithm of equation (1) and rearranging it, the following equation (2) is obtained.

$$[ Equation 2 ]$$

$$ln {t}_{f} = - α \cdot ln [ {( \frac{d ε}{dt} )}_{S} ] + ln M \qquad ( 2 )$$

Therefore, three creep tests on a certain material to measure the steady-state creep rate (dε/dt)_{S} and the creep fracture life t_{f} to plot the three points on a double logarithmic graph of t_{f} versus (dε/dt)_{S}, results in a linear relationship as shown in FIG. 4. FIG. 4 shows an example of a double logarithmic graph in which the creep fracture life t_{f} is plotted with respect to steady-state creep rate (dε/dt)_{S}. Since the vertical intercept of this line is 1 nM and the slope of the line is −α, M and α are obtained from this graph. In a case where M and a are known, the creep fracture life t_{f} can be calculated from equation (1) by measuring the steady-state creep rate (dε/dt)_{S}.

The inventors have found that the parameter a in equation (1) can be used in common throughout a certain group of materials G1 when evaluating the creep fracture life t_{f} and certain material properties. In other words, according to the inventors' discovery, if the target material TM and the reference material RM both belong to a certain group of materials G1, the value of the parameter a for the reference material RM can be diverted to evaluate the target member T composed of the target material TM. Herein, “can be used in common throughout a certain group of materials” means that the evaluation results are accurate enough for practical use when a certain parameter p1 for a material M1 belonging to a group of materials G is used in the evaluation of a member composed of another material M2 belonging to the same group of materials G.

The inventors have also found that the parameter M in equation (1) can be used in common throughout a certain group of materials G2 when evaluating the creep fracture life t_{f} and certain material properties. In other words, according to the inventors' discovery, if the target material TM and the reference material RM both belong to a certain group of materials G2, the value of the parameter M for the reference material RM can be diverted to evaluate the target member T composed of the target material TM.

Furthermore, the inventors have found that if the parameter M can be used in common for two types of materials, the parameter a can also generally be used in common. In other words, in a certain group of materials G2, where the parameter M can be used in common, both parameters α and M can be diverted. Therefore, according to the inventors' discovery, if the target material TM and the reference material RM both belong to a certain group of materials G2, the creep fracture life t_{f} of the target member T can be evaluated from the steady-state creep rate (dε/dt)_{S} of the target member T based on equation (1), by diverting the values of a and M for the reference material RM.

Ordinarily, in order to predict a creep fracture life t_{f} of a material, it is necessary to first determine the values of creep ductility M and a by performing at least three creep tests on the material in question. However, according to the above inventors' discovery, the creep fracture life t_{f} of the target member T can be calculated as long as the steady-state creep rate (dε/dt)_{S} of the target member T can be determined, by using the values of a and M for the reference material RM, which belongs to the same group of materials as the target material TM. Since the steady-state creep rate (dε/dt)_{S} can be obtained without fracturing the target member T, this principle allows the creep fracture life t_{f} of the target member T to be evaluated without performing a fracture creep test.

The above relationship is illustrated in FIG. 5. FIG. 5 is a conceptual diagram showing an example of the relationship between the reference material RM and the target material TM. As shown in FIG. 5, a reference material RM and two target materials TM1 and TM2 belong to a group of materials G1, where the parameter a can be used in common, and the reference material RM and the target material TM2 belong to group of materials G2, where both parameters α and M can be used in common. In this case, only the parameter a of the reference material RM can be diverted for evaluation of the target material TM1 whereas both parameters α and M of the reference material RM can be diverted for evaluation of the target material TM2.

As described above, the certain group of materials to which the target material TM and the reference material RM belong, is a group consisting of one or more materials for which one or more of the parameters α and M can be used in common, which define the relationship between the steady-state creep rate (dε/dt)_{S} and the creep fracture life t_{f}, when evaluating the creep fracture life t_{f} from the steady-state creep rate (dε/dt)_{S}. For example, the certain group of materials to which the target material TM and the reference material RM belong, can be a group of materials which has one or more of the following (a) to (f) substantially in common.
a. One or more characteristics specified in the standard (e.g., standard classification, standard number, standard name, composition of components, use)
b. System of materials (e.g., material class defined by standards or technical common knowledge, such as 9-12Cr steel, Cr—Mo—V steel, 2.25Cr—Mo steel)
c. The type of principal constituent element (i.e., the element with the largest mass % among the constituent elements)
d. Type and content of the second most contained element by mass % (note that a certain deviation in content are tolerated based on technical common knowledge)
e. The type and content of element(s) which has a significant effect on the principal properties of the material (a certain deviation in content is tolerated based on technical common knowledge)
f. Chemical constituent(s) (i.e., constituent element(s) except for unavoidable impurities and their content (a certain deviation in content is tolerated based on technical common knowledge))

### (2-1-1-1. Example of Homogeneous Material)

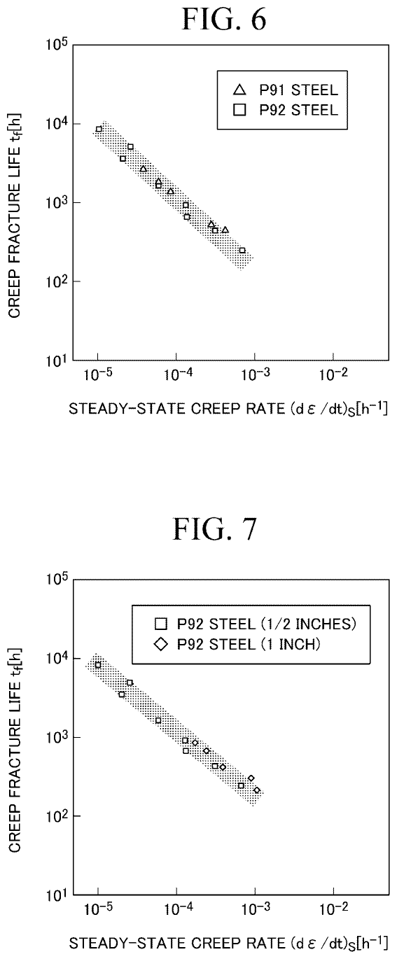

For example, P91 steel (9Cr steel) and P92 steel (W-added 9Cr steel) belong to a group of materials for which a and M can be used in common. A plurality of fracture creep tests on a ½-inch CT specimen were performed on each of the P91 and P92 steels at temperatures of 580° C. to 630° C. FIG. 6 shows double logarithmic plots of the steady-state creep rate (dε/dt)_{S} and the creep fracture life t_{f} obtained from the fracture creep tests on P91 and P92 steels. The white triangles in FIG. 6 represent the test results for P91 steel, and the white squares represent the test results for P92 steel.

The P91 and P92 steels were confirmed to be on the same straight line in the double logarithmic graph. In other words, P91 and P92 steels were confirmed to belong to a group of materials for which the parameters α and M can be used in common. Both P91 and P92 steels are 9Cr steels containing about 9 mass % Cr. P92 steel has about 1.5 to 2 mass % W added in comparison with P91 steel. Thus, it has been confirmed that the parameters α and M can be used in common for two steel materials belonging to the same steel grade (9Cr steel), even if there are some differences in the content of non-principal elements.

Then, a plurality of fracture creep tests were performed at temperatures of 580° C. to 630° C. on each of the ½-inch CT specimens of P92 steel and 1-inch CT specimens of P92 steel to investigate the effect of the different morphologies of the members on the parameters α and M. FIG. 7 is double logarithmic plots of the steady-state creep rate (dε/dt)_{S} and the creep fracture life t_{f} obtained from the fracture creep tests on the ½-inch CT specimen and the 1-inch CT specimen of P92 steel. The white squares in FIG. 7 represent the test results of the ½-inch CT specimen, and the white diamonds represent the test results of the 1-inch CT specimen.

The ½-inch and 1-inch CT specimens of P92 steel were confirmed to lie on the same straight line on the double logarithmic graph. In other words, it was confirmed for the same material that the effect of the difference in specimen size is very small and that the parameters α and M can be used in common.

### (2-1-1-2. Example of Weld Joint Member)

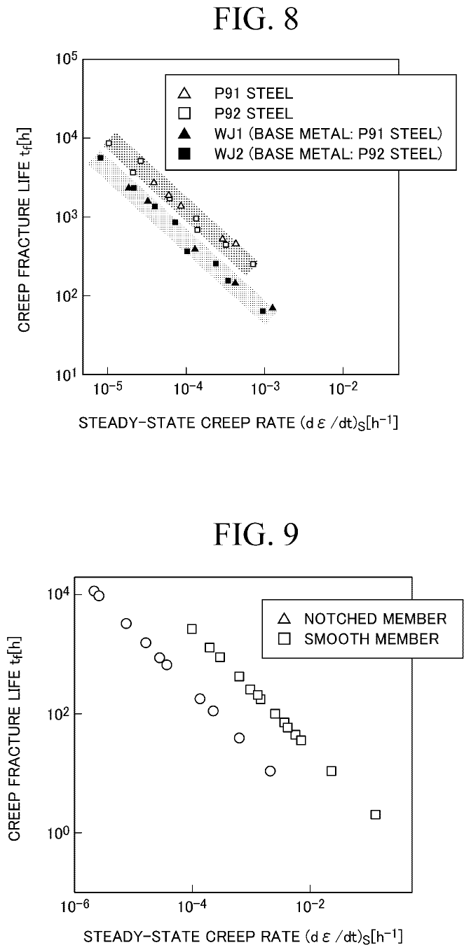

Then, an example of weld joint members formed using the above CT specimens of P91 and P92 steel as base metals, respectively, is described. A plurality of fracture creep tests were performed at temperatures of 580° C. to 630° C. on a weld joint member WJ1 composed of two members made of P91 steel welded together by weld metal TG-CB (9Cr-1Mo-VNb). Similarly, plurality of fracture creep tests were performed at temperatures of 580° C. to 630° C. on a weld joint member WJ2 composed of two members made of P92 steel welded together with weld metal 11Cr-0.4Mo-2WCuVNb steel. FIG. 8 is double logarithmic plots of the steady-state creep rate (dε/dt)_{S} and the creep fracture life t_{f} obtained from the fracture creep tests of the weld joint member WJ1 and the weld joint member WJ2. The black triangles in FIG. 8 represent the test results of the weld joint member WJ1, including P91 steel as the base metal, and the black squares represent the test results of the weld joint member WJ2, including P92 steel as the base metal. Note that the white triangles represent the test results for the base metal of P91 steel alone, and the white squares represent the test results for the base metal of P92 steel alone.

The weld joint member WJ1 and weld joint member WJ2 were confirmed to lie on the same straight line in the double logarithmic graph. The straight line of the weld joint member WJ1 and the weld joint member WJ2 was generally parallel to (i.e., having a which is generally the same as) the straight line of the base metal of the P91 and P92 steels alone, with different intercepts. Therefore, it was confirmed that the weld joint members WJ1 and WJ2 belong to a group of materials in which a and M can be used in common, and that a can be used in common for the weld joint members WJ1 and WJ2 in comparison with the base metals, P91 and P92 steels, although M is different.

### (2-1-1-3. Example of Notched Member and Smooth Member)

Then, an example of a notched member and a smooth member made of Cr—Mo—V steel is described. A plurality of fracture creep tests were performed at a temperature of 600° C. on each of the notched member and the smooth member made of Cr—Mo—V steel. FIG. 9 is double logarithmic plots of the steady-state creep rate (dε/dt)_{S} and the creep fracture life t_{f} obtained from the fracture creep tests for the notched member and the smooth member. The white squares in FIG. 9 represent the test results for the notched member made of Cr—Mo—V steel, and the white circles represent the test results for the smooth member made of Cr—Mo—V steel.

On the double logarithmic graph, the straight line of the notched member and the straight line of the smooth member were generally parallel (i.e., a was generally the same as each other) with different intercepts. Therefore, comparing the notched member and the smooth member made of Cr—Mo—V steel, it was confirmed that a can be used in common although M is different.

### (2-1-1-4. Example of Notched Member and Smooth Member of Weld Joint Member)

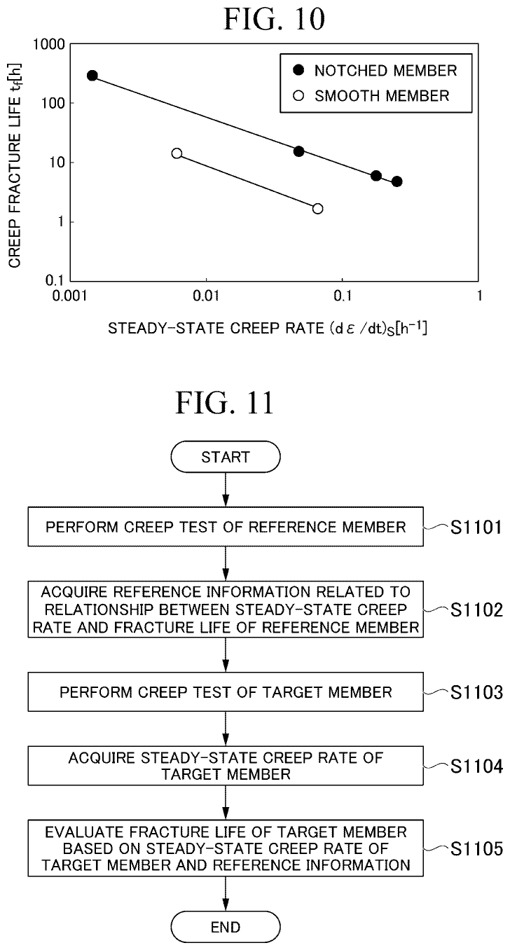

Then, an examples of a notched member and a smooth member with regard to a weld joint member including SM400 steel as base metal and 2.25Cr—Mo steel as weld metal are described. A plurality of fracture creep tests were performed at a temperature of 600° C. on each of the notched member and the smooth member of the weld joint member described above. FIG. 10 is double logarithmic plots of the steady-state creep rate (dε/dt)_{S} and the creep fracture life t_{f} obtained from the fracture creep tests on the notched member and the smooth member. The black circles in FIG. 10 represent the test results for the notched member, and the white circles represent the test results for the smooth member.

On the double logarithmic graph, the straight line of the notched member and the straight line of the smooth member were generally parallel (i.e., a was generally the same as each other) with different intercepts. Therefore, comparing the notched member and the smooth member of the weld joint member above, it was confirmed that a can be used in common although M is different.

### (2-1-2. Evaluation of Material Properties)

Then, the principle of how the evaluation system 1 evaluates the material properties of the target material TM is described. The evaluation of the material properties of the target material TM is based on the following equation (3). In equation (3), σ₀ is the applied stress at the start of the creep test (an example of the “third physical amount”), and A and m are material-dependent constants. Both A and m are examples of the “second parameters. The applied stress σ₀ is obtained by dividing the load (tensile force) applied to a specimen W by the cross-sectional area of the specimen W at the start of the test. Equation (3) and the parameters A and m included in equation (3) are examples of the information related to the relationship between the steady-state creep rate (an example of the “first physical amount”) and the applied stress (an example of the “third physical amount”).

$$[ Equation 3 ]$$

$${( \frac{d ε}{dt} )}_{S} = A {σ}_{0}^{m} \qquad ( 3 )$$

Substituting equation (3) into equation (1), the following equation (4), which expresses the relationship between the creep fracture life t_{f} and the applied stress σ₀, is obtained. Equation (4) and the parameters α, M, A, and m in equation (4) are examples of the information related to the relationship between the creep fracture life (an example of the “second physical amount”) and the applied stress (an example of the “third physical amount”).

$$\begin{matrix}[ Equation 4 ] & \\ {t}_{f} = {MA}^{- α} {σ}_{0}^{- α m} & ( 4 )\end{matrix}$$

Here it is assumed that the reference material RM and the target material TM belong to a certain group of materials G2, in which a and M can be used in common, and that a and M of the reference material RM are known. Provided the applied stress to the reference material RM is σ_{0R} and the creep fracture life of the reference material RM is t_{fR}, the relationship between the creep fracture life to and the applied stress σ_{0R} is expressed by the following equation (5). A_{R} and m_{R} are the material constants A and m of the reference material RM. The material constants A_{R} and m_{R} of the reference material RM can be obtained from the intercept and slope of the double logarithmic graph in which the creep fracture life t_{fR} is plotted with respect to the applied stress σ_{0R}, by performing three creep tests on the reference material RM.

$$\begin{matrix}[ Equation 5 ] & \\ {t}_{fR} = {MA}_{R}^{- α} {σ}_{0 R}^{- α {m}_{R}} & ( 5 )\end{matrix}$$

Based on equation (5), the material properties of the target material TM with unknown material constants A_{T} and m_{T} can be evaluated without using the material constants A_{T} and M_{T}. First, the steady-state creep rate (dε/dt)_{ST} of the target member T, which is composed of the target material TM, is measured by creep test. Since a and M of the reference material RM can be diverted to the target material TM, the creep fracture life t_{fT} of the target member T can be calculated from the steady-state creep rate (dε/dt)_{ST} of the target material T according to equation (1), as shown in equation (6) below.

$$\begin{matrix}[ Equation 6 ] & \\ {t}_{fT} = M \cdot {( \frac{d ε}{dt} )}_{ST}^{- α} & ( 6 )\end{matrix}$$

In order to evaluate the material properties of the target material TM, a “converted stress” σ_{0TCR} is defined by the following equation (7) or equation (8). Equation (8) is the solution of equation (7) for the converted stress σ_{0TCR}.

$$\begin{matrix}[ Equation 7 ] & \\ {f}_{fT} = {MA}_{R}^{- α} {σ}_{0 {TCR}^{- α {m}_{R}}} & ( 7 )\end{matrix}$$

$$\begin{matrix}[ Equation 8 ] & \\ {σ}_{0 TCR} = {M}^{\frac{1}{α {m}_{R}}} {A}_{R}^{- \frac{1}{{m}_{R}}} {t}_{fT}^{- \frac{1}{α {m}_{R}}} & ( 8 )\end{matrix}$$

According to equations (7) and (8), the virtual stress σ_{0TCR} (the converted stress, an example of the “converted third physical amount”) is back-calculated from the creep fracture life t_{fT} of the target member T by diverting the material constants A_{R} and m_{R} of the reference material RM. In other words, the converted stress σ_{0TCR} is the value obtained by back-calculating the amount corresponding to the applied stress σ_{0T} from the creep fracture life t_{fT} of the target member T under the assumption that the relational expression (5) between the creep fracture life t_{fR} and the applied stress σ_{0R}, which is defined with the material constants A_{R} and m_{R} of the reference material RM, is also valid for the target member T. Comparison of this converted stress σ_{0TCR} with the actual applied stress GOT applied to the target member T allows the material properties of the target material TM to be evaluated. In other words, the converted stress ratio η is defined by the following equation (9).

$$\begin{matrix}[ Equation 9 ] & \\ η ≡ \frac{{σ}_{0 TCR}}{{σ}_{0 T}} & ( 9 )\end{matrix}$$

The converted strength η* is defined as the reciprocal of the converted stress ratio η, according to the following equation (10).

$$\begin{matrix}[ Equation 10 ] & \\ {η}^{*} ≡ \frac{1}{η} = \frac{{σ}_{0 T}}{{σ}_{0 TCR}} & ( 10 )\end{matrix}$$

In a case of η>1 and η*<1, the following holds: σ_{0T}<σ_{0TCR}. The converted stress σ_{0TCR} can be interpreted as the applied stress required to give a certain creep rate (dε/dt)_{ST} in the reference material RM. Therefore, the relationship of σ_{0T}<σ_{0TCR} means that the applied stress required to give the certain creep rate (dε/dt)_{ST} is greater in the reference material RM than in the target material TM. This can be interpreted to mean that the resistance to creep deformation (e.g., creep strength) of the target material TM is less than that of the reference material RM.

In contrast, in a case of η<1 and η*>1, the following holds: σ_{0T}>σ_{0TCR}. This can be interpreted to mean that the resistance to creep deformation (e.g., creep strength) of the target material TM is greater than that of the reference material RM. In a case of η=η*=1, the resistance to creep deformation (e.g., creep strength) of the target material TM and the reference material RM can be evaluated to be equivalent.

In this way, regarding the reference material RM and the target material TM belonging to the group of materials G2 in which a and M can be used in common, even if the material constants A_{T} and m_{T} of the target material TM are unknown, the material properties (e.g., creep strength) of the target material TM with respect to the reference material RM can be evaluated by calculating the converted stress σ_{0TCR}. The evaluation of such material properties can be done based solely on the steady-state creep rate (dε/dt)_{ST} obtained from a non-fracture creep test of the target member T, similar to the evaluation of the creep fracture life t_{f} described above.

Although the material property to be evaluated here is resistance to creep deformation, other material properties may be evaluated. Examples of other material properties include creep properties related to resistance to creep deformation from a different viewpoint (e.g., ease of creep deformation, resistance to creep fracture), and material properties which contribute to creep deformation (e.g., matrix strength, textural stability).

Although the converted stress σ_{0TCR} is calculated from the creep fracture life t_{fT} in the above example, the converted stress σ_{0TCR} may be calculated from the steady-state creep rate (dε/dt)_{ST}. The calculation results would be identical.

(2-1-3. Evaluation for Case with Different Parameter M)

Then, the case where the parameter a can be used in common for the reference material RM and the target material TM but the parameter M is different, is considered. This corresponds to the relationship between the reference material RM and the target material TM1 in FIG. 5.

If the parameters M of the reference material RM cannot be diverted to evaluate the target material TM, one fracture creep test of the target member T is required. That is, the steady-state creep rate (dε/dt)_{ST} and the creep fracture life t_{fT} of the target member T are measured by performing one creep test until the target member T fractures. Provided the creep ductility of the target material TM is M′, the following equation (11) follows from the above equation (1). Therefore, the value of M′ can be calculated by diverting the parameter a of the reference material RM.

$$\begin{matrix}[ Equation 11 ] & \\ {t}_{fT} = {M}^{′} \cdot {( \frac{d ε}{dt} )}_{ST}^{- α} & ( 11 )\end{matrix}$$

Once M′ is obtained from equation (11), it is possible to evaluate the creep fracture life t_{f} of the target member T from the steady-state creep rate (dε/dt)_{S} of the target member T using this value of M′ and the value of a for the reference material RM.

In this way, although it is ordinarily necessary to repeat the fracture creep test of the target member T three times to generate the evaluation equation for the creep fracture life t_{f} of the target member T, the above method allows the evaluation equation for the creep fracture life t_{f} of the target member T to be generated by only one fracture creep test of the target member T.

The evaluation method using a converted stress σ_{0TCR} described in 2-1-2 above is also applicable in this case. In other words, the converted stress σ_{0TCR} is defined by the following equation (12), using the measured or evaluated value of the creep fracture life t_{fT} of the target member T. Equation (12) is identical to equation (7) above. M is the creep ductility of the reference material RM, which is different from the creep ductility M′ of the target material TM.

$$\begin{matrix}[ Equation 12 ] & \\ {t}_{fT} = {MA}_{R}^{- α} {σ}_{0 {TCR}^{- a {m}_{R}}} & ( 12 )\end{matrix}$$

From the converted stress ratio r) or converted strength η* defined as in 2-1-2 above, the creep strength of the target material TM with respect to the reference material RM can be evaluated. In other words, in a case of η>1 and η*<1, σ_{0T}<σ_{0TCR} and thus the creep strength of the target material TM can be evaluated to be less than that of the reference material RM. Conversely, in a case of η<1 and η*>1, σ_{0T}>σ_{0TCR} and thus the creep strength of the target material TM is evaluated to be greater than that of the reference material RM.

### (2-1-4. Effect of Shape)

As mentioned above, not only for high temperature ductile materials such as Cr—Mo—V steel and 2.25Cr—Mo steel, but also for high Cr steels such as 9Cr steels, in double logarithmic plots of the steady-state creep rate (dε/dt)_{S} and the creep fracture life t_{f} (so-called QL* line plotting), the QL* line for the base metal and the QL* line for the weld material are generally coincident with, or parallel to, each other. In particular, the QL* line for creep ductile materials can be deemed to be on the same line. Here, the effect of the shape of the members can be discussed by the local stress multiaxiality (TF) defined by the following equation (13). The local stress multiaxiality TF is defined as the value obtained by dividing the average σ_{P} of the X-direction stress σₓ, the Y-direction stress σ_{y}, and the Z-direction stress σ_{z} in the multiaxial stress state by an equivalent stress (expressed in σ bar).

$$\begin{matrix}[ Equation 13 ] & \\ TF ≡ \frac{{σ}_{p}}{\overline{σ}} = \frac{{σ}_{x} + {σ}_{y} + {σ}_{z}}{3 \overline{σ}} & ( 13 )\end{matrix}$$

At least for creep ductile materials, in a case where two members made of the same material or the same family of materials have comparable TFs, their QL* lines are coincident with each other. In this case, a and M can be used in common for both members. On the other hand, in a case where the TFs are different from each other, the QL* lines may not be coincident with each other but generally parallel. In this case, a can be used in common for both members, but M is not common. Therefore, in order to simplify the evaluation of the target member T, it is preferable that the target member T and the reference member R have a local stress multiaxiality TF which are coincident with each other within a certain tolerance.

### (2-2. Processing Flow)

Then, the processing flow of the evaluation method by the evaluation system 1 is described. The following three examples are described as examples of the evaluation method by the evaluation system 1.

(2-2-1) Example of evaluating a creep fracture life t_{f} of a target member T composed of a target material TM to which a and M of a reference material RM can be diverted

(2-2-2) Example of evaluating material properties of a target member T composed of a target material TM to which a and M of a reference material RM can be diverted

(2-2-3) Example of evaluating a creep fracture life t_{f} of a target member T composed of a target material TM to which a of a reference material RM can be diverted

(2-2-1. Example of evaluating a creep fracture life t_{f} of a target member T composed of a target material TM to which a and M of a reference material RM can be diverted)

First, with reference to FIG. 11, the processing flow in example (a) is described. In example (a), a reference material RM and a target material TM belong to a group of materials G2, where a and M can be used in common. FIG. 11 is a flowchart showing an example of the processing flow for evaluating a creep fracture life t_{f} of a target member T.

In step S1101, the test device 10 performs a creep test on a reference member R composed of the reference material RM. Specifically, the test device 10 performs at least three fracture creep tests, which are performed until the reference member R fractures. Creep tests can be performed in accordance with the provisions of JIS Z 2271 (2010). The load sensor 132 and the displacement sensor 134 measure the load applied to a specimen W and the displacement of the specimen W at certain time intervals. The acquiring unit 200 acquires load and displacement measurements.

In step S1102, the data processing unit 222 generates a creep curve C of the reference member R from the measurements acquired by the acquiring unit 200. The data processing unit 222 identifies the steady-state creep region and calculates the steady-state creep rate (dε/dt)_{S} of the reference member R. The data processing unit 222 acquires the creep fracture life t_{f} of the reference member R. The three fracture creep tests result in three pairs of the steady-state creep rate (dε/dt)_{S} and the creep fracture life t_{f}. The relationship determining unit 224 generates double logarithmic plots, as shown in FIG. 5, for the obtained pairs of the steady-state creep rate (dε/dt)_{S} and the creep fracture life t_{f}. The relationship determining unit 224 generates a straight line which approximates the plots on the double logarithmic graph, and calculates the parameters M and a from the intercept and slope of the line. These parameters M and a are reference information which defines the relationship between the steady-state creep rate (dε/dt)_{S} and the creep fracture life t_{f} of the reference member R.

In step S1103, the test device 10 performs a creep test on the target member T composed of the target material TM. Specifically, the test device 10 performs a non-fracture creep test until the steady-state creep rate (dε/dt)_{S} of the target member T is acquired. For example, a non-fracture creep test is performed until the end of the steady-state creep region of the target member T, and the creep test is terminated when the steady-state creep region is exited. As an example, during the creep test, each time the acquiring unit 200 acquires displacement data, the data processing unit 222 calculates the strain rate dε/dt. The data processing unit 222 determines whether the creep test in progress is before the steady-state creep region, within the steady-state creep region, or after the steady-state creep region, based on the strain rate dε/dt. In a case where the data processing unit 222 determines that the steady-state creep region has been exited, the test device 10 can terminate the creep test.

In step S1104, the data processing unit 222 generates a creep curve C for the target member T and calculates the steady-state creep rate (dε/dt)_{S}.

In step S1105, the life evaluating unit 226 applies the following equation (14) for the reference member R to the target member T, and calculates the creep fracture life t_{f} of the target member T from the steady-state creep rate (dε/dt)_{S} of the target member T using the parameters α and M for the reference material RM. The outputting unit 260 outputs the creep fracture life t_{f} of the target member T evaluated by the life evaluating unit 226 to the user.

$$\begin{matrix}[ Equation 14 ] & \\ {t}_{f} = M \cdot {( \frac{d ε}{dt} )}_{S}^{- α} & ( 14 )\end{matrix}$$

(2-2-2. Example of evaluating material properties of a target member T composed of a target material TM to which a and M of a reference material RM can be diverted)

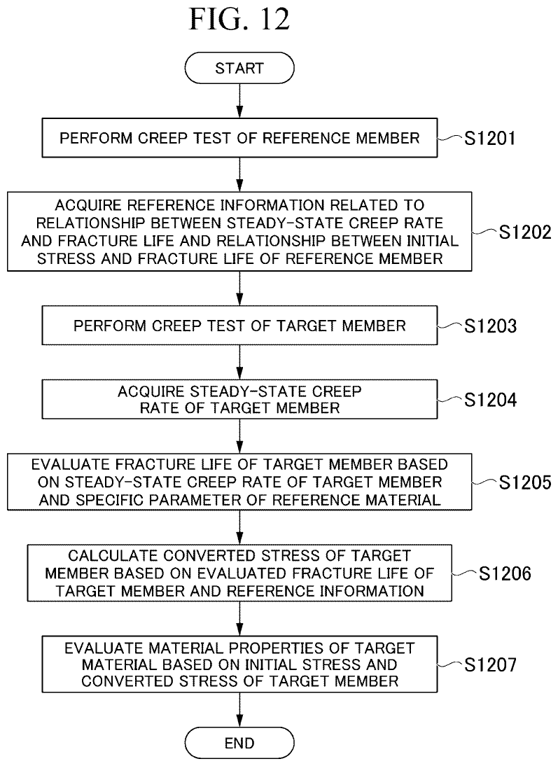

Then, with reference to FIG. 12, the processing flow in example (b) is described. In example (b), a reference material RM and a target material TM belong to a group of materials G2, where a and M can be used in common. FIG. 12 is a flowchart showing an example of the processing flow for evaluating the material properties of the target material TM.

In step S1201, as in step S1101, the test device 10 performs a creep test on a reference member R composed of the reference material RM. Specifically, the test device 10 performs at least three fracture creep tests, which are performed until the reference member R fractures.

In step S1202, as in step S1102, the data processing unit 222 acquires the steady-state creep rate (dε/dt)_{SR} and the creep fracture life t_{fR} of the reference member R. The relationship determining unit 224 calculates the parameters M and a of the reference material RM from the linear approximation of the double logarithmic plots. These parameters M and a are reference information which defines the relationship between the steady-state creep rate (dε/dt)_{SR} and creep fracture life t_{R} of the reference member R.

In addition, the relationship determining unit 224 generates double logarithmic plots of the creep fracture life t_{f} versus the applied stress σ₀ applied to the reference member R. The relationship determining unit 224 determines the material constants A_{R} and m_{R} of the reference material RM from a linear approximation of the double logarithmic plots based on the following equation (15). Note that equation (15) is identical to equation (5) above. These parameters A_{R} and m_{R} are reference information which defines the relationship between the applied stress σ₀ and the creep fracture life t_{f} of the reference member R.

$$\begin{matrix}[ Equation 15 ] & \\ {t}_{fR} = {MA}_{R}^{- α} {σ}_{0 R}^{- α {m}_{R}} & ( 15 )\end{matrix}$$

In step S1203, as in step S1103, the test device 10 performs a non-fracture creep test on the target member T. In step S1204, as in step S1104, the data processing unit 222 calculates the steady-state creep rate (dε/dt)_{ST} of the target member T. In step S1205, as in step S1105, the life evaluating unit 226 calculates the creep fracture life t_{fT} of the target member T from the steady-state creep rate (dε/dt)_{ST} of the target member T, using the parameters α and M of the reference material RM.

In step S1206, the converting unit 228 calculates a converted stress σ_{0TCR} from the creep fracture life t_{fT} calculated by the life evaluating unit 226, based on the following equation (16). Note that equation (16) is identical to equation (7) above. The parameters α, M, A_{R}, and m_{R} in the equation are those obtained in step S1202.

$$\begin{matrix}[ Equation 16 ] & \\ {t}_{fT} = {MA}_{R}^{- α} {σ}_{0 TCR}^{- α {m}_{R}} & ( 16 )\end{matrix}$$

In step S1207, the material property evaluating unit 230 calculates a converted stress ratio η, which is obtained by dividing the converted stress σ_{0TCR} calculated by the converting unit 228 by the applied stress σ_{0T} of the target member T. The material property evaluating unit 230 evaluates the material properties of the target material TM with respect to the reference material RM by examining the magnitude relationship between η and 1. As described above, the material property evaluating unit 230 evaluates that the creep strength of the target material TM is less than that of the reference material RM in a case of η>1. The material property evaluating unit 230 evaluates that the creep strength of the target material TM is greater than that of the reference material RM in a case of η<1. The material property evaluating unit 230 evaluates that the creep strength of target material TM is comparable with that of reference material RM in a case of η=1. Note that the material property evaluating unit 230 may use a converted strength η*, the reciprocal of η, as an evaluation criterion, or simply compare the converted stress σ_{0TCR} to the applied stress σ_{0T}. The outputting unit 260 outputs to a user the creep fracture life t_{f} of the target member T evaluated by the life evaluating unit 226 and the results of the evaluation of the material properties of the target material TM by the material property evaluating unit 230.

(2-2-3. Example of evaluating a creep fracture life t_{f} of a target member T composed of a target material TM to which a of a reference material RM can be diverted)

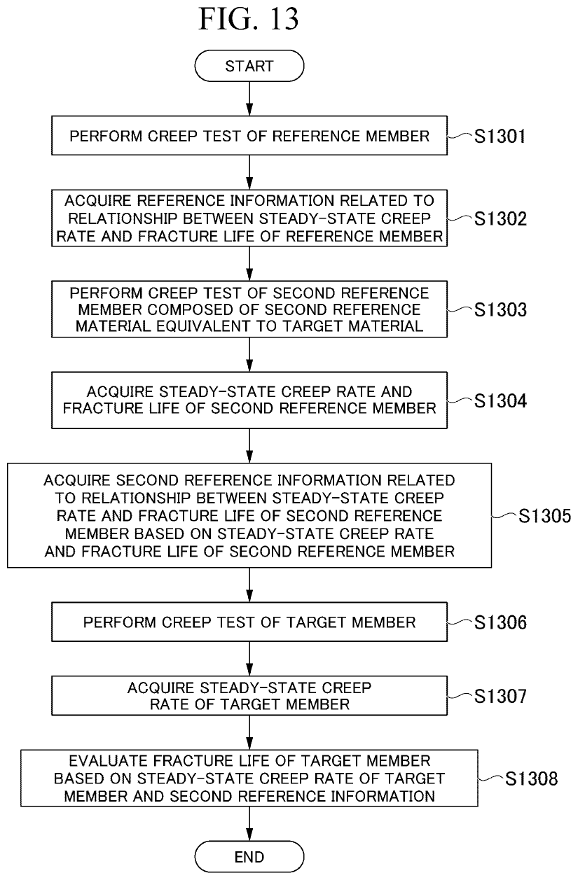

Then, with reference to FIG. 13, the processing flow in example (c) is described. In example (c), a reference material RM and a target material TM belong to a group of materials G1, where a can be used in common. However, M differs between the reference material RM and the target material TM. FIG. 13 is a flowchart showing an example of the processing flow for evaluating the creep fracture life t_{f} of the target member T.

In steps S1301 to S1302, as in steps S1101 to S1102, the test device 10 performs a fracture creep test of a reference member R, and the relationship determining unit 224 determines the parameters α and M of the reference material RM.

In step S1303, a second reference member R2 composed of a second reference material RM2 which is equivalent to the target material TM, is prepared. Here, the two materials being “equivalent” means that the two materials belong to a certain group of materials for which the parameters α and M can be used in common. The test device 10 performs at least one fracture creep test on the second reference member R2. The acquiring unit 200 acquires load and displacement measurements of a specimen W of the second reference member R2 from the load sensor 132 and the displacement sensor 134.

In step S1304, the data processing unit 222 generates a creep curve C of the second reference member R2 based on the load and displacement data acquired by the acquiring unit 200. The data processing unit 222 acquires the steady-state creep rate (dε/dt)_{SR2} and the creep fracture life t_{fR2} of the second reference member R2.

In step S1305, the relationship determining unit 224 determines the parameter M′ for the second reference material RM2 by substituting the parameter a of the reference material RM, and the steady-state creep rate (dε/dt)_{SR2} and creep fracture life t_{fR2} of the second reference member R2 obtained in step S1303, to the following equation (17). The determined parameter M′ and the parameter a of the reference material RM are the second reference information which specifies the relationship between the steady-state creep rate (dε/dt)_{S} and creep fracture life t_{f} of the second reference member R2.

$$\begin{matrix}[ Equation 17 ] & \\ {t}_{fR 2} = {M}^{′} \cdot {( \frac{d ε}{dt} )}_{SR 2}^{- α} & ( 17 )\end{matrix}$$

In step S1306, as in step S1103, the test device 10 performs a non-fracture creep test on the target member T. In step S1307, as in step S1104, the data processing unit 222 calculates the steady-state creep rate (dε/dt)_{ST} of the target member T. In step S1308, as in step S1105, the life evaluating unit 226 calculates the creep fracture life t_{fT} of the target member T from the steady-state creep rate (dε/dt)_{ST} of the target member T, using the parameter a of the reference material RM and the parameter M′ of the second reference material RM2. The outputting unit 260 outputs the creep fracture life t_{f} of the target member T evaluated by the life evaluating unit 226 to a user.

### (2-3. Accuracy of Evaluation of Creep Fracture Life t_{f})

Experiments were conducted to confirm the accuracy of evaluation of the creep fracture life t_{f} in a case where the base metal and the weld material belong to a group of materials for which the parameters α and M can be used in common. Specifically, a DEN specimen of P91 steel (9Cr steel) was used as the base metal and US-9Cb was used as the weld material. The base metal P91 steel and the weld material US-9Cb belong to a group of materials (9Cr steel) for which the parameters α and M can be used in common.

Three fracture creep tests were conducted on P91 steel (base metal) to determine each parameter. Provided that the creep fracture life, the steady-state creep rate, and the applied stress of P91 steel (base metal) are t_{B}, (dε/dt)_{SB}, and σ_{0B}, respectively, the following equations (18) to (20) were obtained from the creep test results.

$$\begin{matrix}[ Equation 18 ] & \\ {t}_{fB} = 0.5 \; 03 {( \frac{d ε}{dt} )}_{SB}^{- 0.925} & ( 18 )\end{matrix}$$

$$\begin{matrix}[ Equation 19 ] & \\ {( \frac{d ε}{dt} )}_{SB} = 3.56 \times 1 {0}^{- 28} {σ}_{0 B}^{11.53} & ( 19 )\end{matrix}$$

$$\begin{matrix}[ Equation 20 ] & \\ {t}_{fB} = 1.234 \times 1 {0}^{25} {σ}_{0 B}^{- 10.67} & ( 20 )\end{matrix}$$

Then, a weld joint member WJ was prepared, in which two base metals made of P91 steel were welded to each other with weld metal US-9Cb. The term “weld joint member” refers to the entire body, including the two base metals welded with each other and the weld joint which welds them together. The steady-state creep rate (dε/dt)_{SWJ} and the creep fracture life t_{fWJ} of the weld joint member WJ were determined by performing a fracture creep test on the weld joint member WJ. The creep tests were conducted in two patterns: one with the applied stress σ₀ set at 135 MPa and the other with the applied stress σ₀ set at 113 MPa.

The results are summarized in the table below.

TABLE 1

| | | | | | | | Creep |
|---|---|---|---|---|---|---|---|
| | | | Steady- | Creep | | Converted | fracture |
| | | Initial | state creep | fracture | Converted | stress ratio | life |
| No. | Target | stress | rate | life | stress | η | ratio |
| 1 | Base | 135 MPa | 1.62 × 10⁻³ | 183.6 h | 135 MPa | 1 | 1 |
| | metal | | h⁻¹ | | | | |
| | Weld | 135 MPa | 5.65 × 10⁻² | Measured: | 187 MPa | 1.39 | 0.052 |
| | joint | | h⁻¹ | 9.5 h | | | |
| | | | | Predicted: | | | |
| | | | | 7.2 h | | | |
| 2 | Base | 113 MPa | 1.44 × 10⁻⁴ | 1519.3 h | 113 MPa | 1 | 1 |
| | metal | | h⁻¹ | | | | |
| | Weld | 113 MPa | 9.00 × 10⁻³ | Measured: | 160 MPa | 1.41 | 0.035 |
| | joint | | h⁻¹ | 55.13 h | | | |
| | | | | Predicted: | | | |
| | | | | 39.3 h | | | |

The measured value of the steady-state creep rate (dε/dt)_{SWJ} of the weld joint member WJ was 0.0565/hour in the creep test with σ₀ set at 135 MPa. The measured value of the creep fracture life t_{fWJ} was 9.5 hours. Since P91 steel and US-9Cb belong to a group of materials (9Cr steel) for which the parameters α and M can be used in common, the above equation (18) was applied to the weld joint member WJ. The predicted value of the creep fracture life t_{fWJ} calculated from the steady-state creep rate (dε/dt)_{SWJ} by the equation (18) was 7.2 hours. Therefore, the measured value (9.5 hours) and the predicted value (7.2 hours) of the creep fracture life t_{fWJ} agreed with each other with about 80% accuracy.

Then, the predicted value of the creep fracture life t_{fWJ} of the weld joint member WJ, 7.2 hours, was used to calculate the converted stress σ_{0WCB} of the weld joint member WJ with respect to the base metal (P91 steel), using the following equation (21). The converted stress ratio η was calculated by dividing the converted stress σ_{0WCB} by the applied stress σ₀.

$$\begin{matrix}[ Equation 21 ] & \\ {t}_{fWJ} ( predicted value ) = 1.234 \times {10}^{25} {σ}_{0 WCB}^{- 10.67} & ( 21 )\end{matrix}$$

The results were σ_{0WCB}=187 MPa and η=1.39. Since η>1, the creep strength of the weld joint member WJ was evaluated to be less than that of the base metal, P91 steel. In fact, at the applied stress σ₀=135 MPa, the creep fracture life t_{fB} of the base metal was 183.6 hours whereas the creep fracture life t_{fWJ} (measured value) of the weld joint member WJ was 9.5 hours. The creep fracture life ratio with respect to the creep fracture life of the base metal t_{fB} was t_{fWJ}/t_{fB}=9.5/183.6=0.052. In other words, it was experimentally confirmed that the resistance of the weld joint member WJ to creep deformation is less than that of the base metal, P91 steel (i.e., the weld joint member WJ is more susceptible to creep deformation and fracture than the base metal, P91 steel).

The measured value of the steady-state creep rate (dε/dt)_{SWJ} of the weld joint member WJ was 0.009/hour in the creep test with σ₀=113 MPa. The measured value of the creep fracture life t_{fWJ} was 55.13 hours. The predicted value of the creep fracture life t_{fWJ} calculated from the steady-state creep rate (dε/dt)_{SWJ} by equation (18) was 39.3 hours. Therefore, the measured and predicted values of the creep fracture life t_{fWJ} agreed with each other with an accuracy of about 70%. The converted stress σ_{0WCB} and the converted stress ratio η were calculated from the predicted value of the creep fracture life t_{fWJ} by equation (21): σ_{0WCB}=160 MPa and η=1.41 (>1). The creep fracture life ratio was t_{fWJ}/t_{fB}=55.13/1519.3=0.036.

From the above, the converted stress ratios it of 1.39 and 1.41 were obtained for the applied stress σ₀=135 MPa and 113 MPa, respectively. This means that the creep strength of the weld joint member WJ is about 39% to 41% smaller than that of the base metal (P91 steel). The variation of the converted stress ratio η was about 0.7%. In contrast, the creep fracture life ratios t_{fWJ}/t_{fB} of 0.052 and 0.036 were obtained, with a variation of about 20%. In this way, it was confirmed that the converted stress ratio η had less variation with respect to the applied stress σ₀ than the creep fracture life ratio and was more accurate. Therefore, it can be said that the converted stress ratio η is an excellent index for evaluating material properties.

In this way, for the target material TM which belongs to the same group of materials as the reference material RM with the known parameters α and M, the creep fracture life t_{f} of the target member T and the material properties of the target material TM can be evaluated with only one non-fracture creep test up to the steady-state creep region. Here, if a normal fracture creep test is performed on the target member T to determine the life law, at least three creep tests are required. For example, if the test hours are 1000, 2000, and 3000 hours, 6000 hours is required in total. In contrast, according to the above method, if the creep fracture life is 1000 hours, for example, the steady-state creep region appears in about 200 hours, ⅕ of 1000 hours, thus reducing the test time to about 1/30. This can improve the efficiency of a creep test.

If the reference material RM and the target material TM have different M but the same a can be used in common for them, one fracture creep test of the target member T has to be performed. However, there is no need to perform the fracture creep test three times since the a of the reference material RM can be used. Thus, the test time can be significantly reduced. It is preferable to perform a fracture creep test of the target member T in the low life range.

Furthermore, by calculating the above converted stress, the material properties of the target material TM can be evaluated with reference to the reference material RM in a short test time. Since it is not necessary to determine the material constants A_{T} and m_{T} of the target material TM, the test time can be significantly reduced. This can improve the efficiency of a creep test.

As described above, according to the evaluation system 1 according to the first embodiment, the creep fracture life t_{f} of the target member T and the material properties of the target material TM can be efficiently evaluated by focusing on the commonality between the target material TM and the reference material RM.

### Second Embodiment

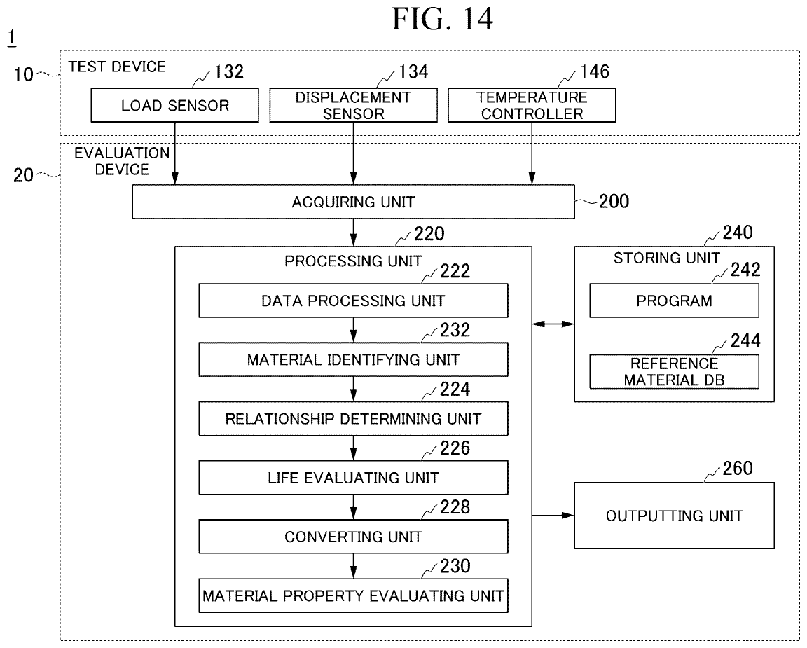

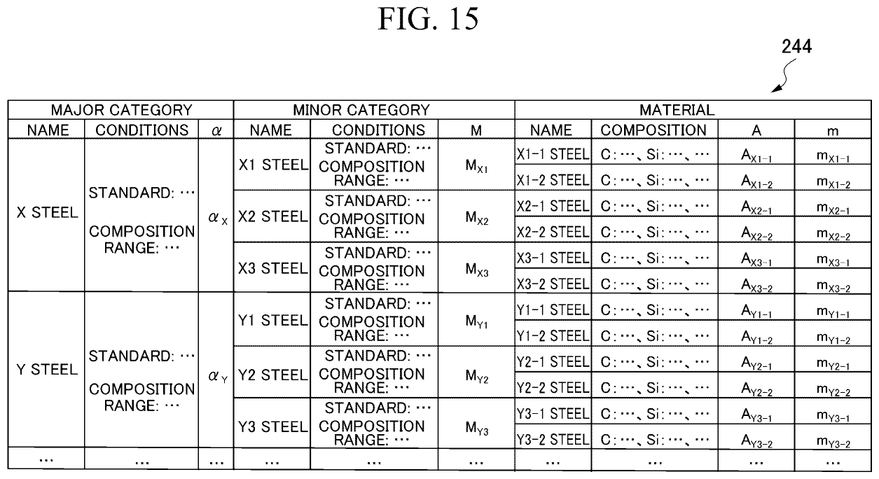

The evaluation system 1 for the second embodiment will be described with reference to FIGS. 14 to 17. The second embodiment differs from the first embodiment in that a reference material database including information on various reference materials RM is used instead of performing a creep test on a reference member R. In the following, differences from the above embodiment are mainly explained, and explanations of points in common with the above embodiment are not repeated.

### 1. Configuration of Evaluation System 1

FIG. 14 is a block diagram showing the functional configuration of the evaluation device 20 in the second embodiment. The configuration of the second embodiment differs from that of the first embodiment shown in FIG. 3 in that the processing unit 220 has a material identifying unit 232 and the storing unit 240 stores a reference material DB 244.

### (Reference Material DB 244)

The storing unit 240 stores the reference material database (DB) 244. The reference material DB 244 is a database including information on one or more reference materials RM. For example, the reference material DB 244 includes a data set showing the relationship between a steady-state creep rate and a creep fracture life for a plurality of reference materials RM. Specifically, the reference material DB 244 can include, for various reference materials RM, component elements and their contents, information representing the relationship between a steady-state creep rate and a creep fracture life (e.g., values of a and M), information representing the relationship between a steady-state creep rate or a creep fracture life and an applied stress (e.g., values of material constant A, material constant m), and material properties (e.g., creep strength). The composition of the reference material RM may be specified by specific mass percentages or other numerical values, or by numerical ranges, for each component element. The reference material DB 244 may be stored on an external server or the like, which is separate from the evaluation device 20.

Each reference material RM is not limited to a specific material, but may be a certain group of materials. For example, the reference material RM is a group of materials for which the parameters α and/or M can be used in common. In this case, the reference material DB 244 can define the boundary of the group of materials by including, for each reference material (or group of materials) RM, information identifying the group of materials, such as classification, standard, numerical range of content of component elements, numerical range of material properties, etc. The reference material DB 244 includes, for each of the reference materials (or group of materials) RM, information on whether or not the parameters α and/or M can be used in common, and the values of parameters α and/or M which can be used in common. The reference material DB 244 may include the information of the reference material RM in a hierarchical structure. For example, the reference material DB 244 may include information on one or more groups of materials and one or more specific materials in each group of materials. The reference material DB 244 may include one or more major categories which indicate a group of materials for which only the parameter a can be used in common, and one or more minor categories which are subdivisions of the major categories and indicate a group of materials for which the parameters α and M can be used in common. In this case, the reference material DB 244 may further include information on one or more specific materials included in each minor category. FIG. 15 shows an example of the data structure of the reference material DB 244.

### (Material Identifying Unit 232)

The material identifying unit 232 identifies a reference material RMs which belong to the same group of materials as the target material TM, among the reference materials RMs included in the reference materials DB 244, based on the information of the target material TM of the target member T. The method of identifying the reference material RM by the material identifying unit 232 is not limited. For example, the material identifying unit 232 can match the component composition of the target material TM with the component composition of the reference materials RM in the reference material DB 244 to identify the reference material RM which matches the component composition of the target material TM, or the reference material RM which encompasses the component composition of the target material TM. Alternatively, the material identifying unit 232 may first extract reference materials RMs which contain the same principal constituent elements as the target material TM, and then identify the reference material RM which is closest to the target material TM in view of the amount of the second most abundant element among the extracted reference materials RM. Any other method can be used. The material identifying unit 232 may use a trained model or the like for which machine learning has been performed on the classification of the target material TM.

### 2. Evaluation Method

Then, the processing flow of the evaluation method using the evaluation system 1 according to the second embodiment will be described.

### (2-1. Processing Flow to Evaluate Creep Fracture Life t_{f} of Target Member T)

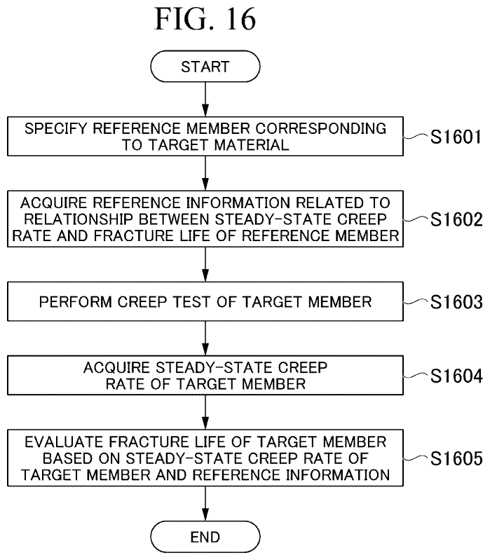

First, with reference to FIG. 16, the processing flow is described for an example of evaluating a creep fracture life t_{f} of a target member T composed of a target material TM, for which the parameters α and M of a reference material RM can be diverted. FIG. 16 is a flowchart showing an example of the processing flow for evaluating the creep fracture life t_{f} of the target member T in the second embodiment.

In step S1601, the acquiring unit 200 acquires information on the target material TM of the target member T from a user input operation or the like. The information on the target material TM includes information for identifying the target material TM. Examples of the information of the target material TM include the product name, standard, type (e.g., steel grade), composition, and physical properties of the target material TM. The material identifying unit 232 identifies the reference material RM corresponding to the target material TM by referring to the reference material DB 244 stored in the storing unit 240. For example, the material identifying unit 232 searches the reference material DB 244 using the information on the target material TM as a key to search for the reference material RM which matches the information on the target material TM or is similar to the target material TM. The outputting unit 260 can present the reference material RM identified by the material identifying unit 232 to the user. The outputting unit 260 may ask the user to confirm whether or not the presented reference material RM is appropriate. The material identifying unit 232 may identify two or more reference materials RM. In this case, the outputting unit 260 may present the user with the two or more identified reference materials RM and ask the user to select the appropriate reference material RM.

The material identifying unit 232 can determine whether the identified reference material RM and the target material TM belong to a group of materials for which both parameters α and M can be used in common or only one of the parameters α and M (e.g., only a) can be used in common.

In step S1602, the relationship determining unit 224 acquires, from the reference material DB 244, information related to the relationship between the steady-state creep rate (dε/dt)_{S} and the creep fracture life t_{f} of the reference material RM identified by the material identifying unit 232. For example, the relationship determining unit 224 acquires, from the reference material DB 244, the values of the parameters α and/or M which can be used in common for the identified reference material RM and the target material TM.

If one of the parameters α and M cannot be used in common for the reference material RM and the target material TM, the outputting unit 260 can notify the user of this fact. In this case, as in 2-2-3 above, the test device 10 performs one fracture creep test on the target member T to determine the parameter which cannot be used in common for the reference material RM and the target material TM.

In step S1603, the test device 10 performs a non-fracture creep test on the target member T in the same manner as in step S1103. The acquiring unit 200 acquires measured values of load and displacement from the load sensor 132 and the displacement sensor 134. In step S1604, the data processing unit 222 calculates the steady-state creep rate (dε/dt)_{S} as in step S1104.

In step S1605, the life evaluating unit 226 calculates the creep fracture life t_{f} of the target member T based on the steady-state creep rate (dε/dt)_{S} of the target member T and the parameters α and M for the reference material RM acquired by the relationship determining unit 224.

### (2-2. Processing Flow to Evaluate Material Properties of Target Material TM)

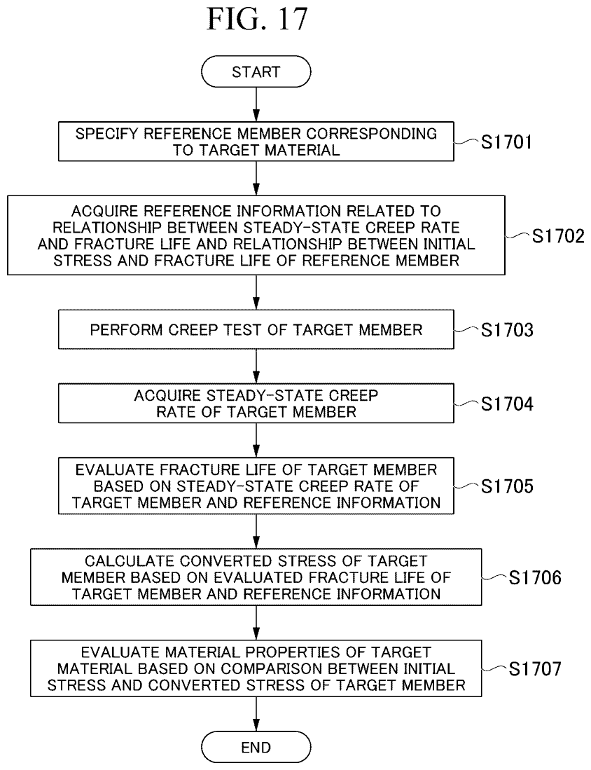

Then, with reference to FIG. 17, the processing flow for evaluating the material properties of the target material TM is described. FIG. 17 is a flowchart showing an example of the processing flow for evaluating the material properties of the target material TM in the second embodiment.

In step S1701, as in step S1601, the material identifying unit 232 identifies the reference material RM corresponding to the target material TM, based on the information of the target material TM acquired by the acquiring unit 200.

In step S1702, the relationship determining unit 224 acquires the parameters α, M, A, m, etc. of the reference material RM from the reference material DB 244. The parameters α and M are reference information which specifies the relationship between the steady-state creep rate (dε/dt)_{S} and creep fracture life t_{f} of the reference member R composed of the reference material RM. The parameters A, m are reference information which specifies the relationship between the applied stress σ₀ and the creep fracture life t_{f} of the reference member R.

If one of the parameters α and M cannot be used in common for the reference material RM and the target material TM, the outputting unit 260 can notify the user of this fact. In this case, as in 2-2-3 above, the test device 10 performs one fracture creep test on the target member T to determine the parameters which cannot be used in common for the reference material RM and the target material TM.

In step S1703, as in step S1603, the test device 10 performs a non-fracture creep test on the target member T. In step S1704, as in step S1604, the data processing unit 222 calculates the steady-state creep rate (dε/dt)_{S} of the target member T. In step S1705, as in step S1605, the life evaluating unit 226 uses a and M of the reference material RM (if a and/or M cannot be used in common for reference material RM and target material TM, a and/or M obtained for target material TM is used) to calculate the creep fracture life t_{f} of the target member T from the steady-state creep rate (dε/dt)_{S} of the target member T.

In step S1706, as in step S1206, the conversion unit 228 calculates the converted stress σ_{0TCR} and the converted stress ratio η=σ_{0TCR}/σ_{0T} (σ_{0T}: applied stress in the creep test of the target member T) from the creep fracture life t_{f} calculated by the life evaluating unit 226, using the material constants A, m of the reference material RM.

In step S1707, as in step S1207, the material property evaluating unit 230 evaluates the material properties of the target material TM based on a comparison of the applied stress σ_{0T} of the target member T and the converted stress σ_{0TCR}.

Thus, according to the evaluation system 1 of the second embodiment, it is possible to more efficiently evaluate the creep fracture life t_{f} of the target member T and the material properties of the target material TM by referring to the existing reference material DB 244.

The instructions indicated in the processing steps shown in the embodiments can be executed based on a program being software. The instructions described in the embodiments are recorded on a magnetic disk, optical disk, semiconductor memory, or other storage medium as a program which can be executed by a computer. The storage medium can be a non-transitory computer-readable recording medium on which the program is recorded.

Although several embodiments of the invention have been described, these embodiments are presented as examples and are not intended to limit the scope of the invention. These embodiments can be implemented in various other forms, and various omissions, substitutions, and modifications can be made without departing from the gist of the invention. These embodiments and variations thereof are included within the scope of the claims and their equivalents as well as within the scope and gist of the invention.

### REFERENCE SIGNS LIST

1: evaluation system, 10: test device, 12: main body, 132: load sensor, 134: displacement sensor, 14: heating mechanism, 20: evaluation device (information evaluating unit), 200: acquiring unit, 220: processing unit, 222: data processing unit, 224: relationship determining unit, 226: life evaluation unit, 228: converting unit, 230: material property evaluating unit, 232: material identifying unit, 244: reference material DB (reference information), T: target member, TM: target material, R: reference member, RM: reference material, R2: second reference member, RM2: second reference material, WJ: weld joint member.

1. An evaluation system for evaluating a target member, comprising an information processing device having a processor,
wherein the processor is configured to:
in a first acquiring step, acquire reference information related to a relationship between a first physical amount and a second physical amount for a reference material, wherein a target material of the target member and the reference material both belong to a certain group of materials, and wherein the first physical amount and the second physical amount for the reference material are different physical amounts related to a creep test of a reference member composed of the reference material;
in a second acquiring step, acquire a first physical amount related to a creep test performed on the target member; and
in an evaluating step, evaluate a second physical amount of the target member based on the reference information and the first physical amount of the target member.

2. The evaluation system according to claim 1, wherein the reference information includes one or more first parameters for specifying a relationship between the first physical amount and the second physical amount for the reference material, and
wherein the processor is configured to evaluate the second physical amount of the target member from the first physical amount of the target member using one or more of the one or more first parameters.

3. The evaluation system according to claim 2, wherein the certain group of materials is a group consisting of one or more materials for which one or more of the one or more first parameters can be used in common when the second physical amount is evaluated from the first physical amount.

4. The evaluation system according to any one of claims 1 to 3, wherein the first physical amount is a steady-state creep rate, and
wherein the second physical amount is a creep fracture life.

5. The evaluation system according to claim 4, wherein the reference information includes information of a parameter M=(dε/dt)_{S}^{α}·t_{f} for the reference material, where (dε/dt)_{S} is the steady-state creep rate of the reference member, α is a constant, and t_{f} is the creep fracture life of the reference member.

6. The evaluation system according to claim 5, wherein the reference information includes information of the parameter a for the reference material.

7. The evaluation system according to any one of claims 1 to 3, wherein the reference information includes information related to a correspondence relationship between the first or second physical amount for the reference material and a third physical amount for the reference material, and
wherein the processor is configured to, in a conversion step, acquire an amount corresponding to the third physical amount, as a converted third physical amount, from the first or second physical amount of the target member, assuming that the correspondence relationship for the reference material is also valid for the target member.

8. The evaluation system according to claim 7, wherein the reference information includes one or more second parameters for specifying the correspondence relationship, and
wherein the processor is configured to, in the conversion step, calculate an amount corresponding to the third physical amount, as a converted third physical amount, from the first or second physical amount of the target member, using one or more of the one or more second parameters.

9. The evaluation system according to claim 7, wherein the processor is configured to:
acquire a third physical amount in the creep test performed on the target member; and
evaluate a material property of the target material based on the acquired third physical amount and the converted third physical amount.

10. The evaluation system according to claim 9, wherein the material property to be evaluated is resistance to creep deformation.

11. The evaluation system according to claim 7, wherein the third physical amount is an applied stress at a start of a test in a creep test.

12. The evaluation system according to any one of claims 1 to 3, wherein the processor is configured to:
in a third acquiring step, acquire second reference information related to a relationship between a first physical amount and a second physical amount for the target material; and
in the evaluating step, evaluate the second physical amount of the target member based on the reference information, the second reference information, and the first physical amount of the target member.

13. The evaluation system according to any one of claims 1 to 3, wherein the reference information includes a data set indicating a relationship between a first physical amount and a second physical amount for a plurality of reference materials, and
wherein the processor is configured to:
identify a reference material which corresponds to the target material among the plurality of reference materials; and
in the first acquiring step, acquire information related to a relationship between a first physical amount and a second physical amount for the identified reference material.

14. The evaluation system according to any one of claims 1 to 3, wherein the target material and the reference material have a same principal constituent element that is the constituent element having a largest mass %.

15. The evaluation system according to any one of claims 1 to 3, wherein the target material and the reference material have a same plurality of chemical constituents as each other.

16. The evaluation system according to any one of claims 1 to 3, wherein the target material and the reference material are one or more selected from the group consisting of heat resistant steel and stainless steel.

17. The evaluation system according to any one of claims 1 to 3, further comprising a test device configured to perform a creep test,
wherein the test device is configured to perform a creep test on the target member, and
wherein the processor is configured to acquire a result of the creep test from the test device.

18. An evaluation method for evaluating a target member, comprising a first acquiring step, a second acquiring step, and an evaluating step,
wherein the first acquiring step includes acquiring reference information related to a relationship between a first physical amount and a second physical amount for a reference material, wherein a target material of the target member and the reference material both belong to a certain group of materials, the first physical amount and the second physical amount for the reference material are different physical amounts related to a creep test of a reference member composed of the reference material,
wherein the second acquiring step includes acquiring a first physical amount related to a creep test performed on the target member, and
wherein the evaluating step includes evaluating a second physical amount of the target member based on the reference information and the first physical amount of the target member.

19. The evaluation method according to claim 18, further comprising the step of performing a creep test on the target member and terminating the creep test before fracture of the target member.

20. A program for causing a processor of an information processing device to evaluate a target member,
wherein the program causes the processor to:
acquire reference information related to a relationship between a first physical amount and a second physical amount for a reference material, wherein a target material of the target member and the reference material both belong to a certain group of materials, and wherein the first physical amount and the second physical amount for the reference material are different physical amounts related to a creep test of a reference member composed of the reference material;
acquire a first physical amount related to a creep test performed on the target member; and
evaluate a second physical amount of the target member based on the reference information and the first physical amount of the target member.
